(19) United States
(12) Patent Application Publication
(10) Pub. No.: US 2005/0021377 A1
(43) Pub. Date: Jan. 27, 2005

(54) Method and system for direct and persistent access to digital medical data

(76) Inventors: Andrew Bruno Dobbs, Vallakra (SE); Alexander Dimitrov Karaivanov, Herlev (DK); Johannes Lubbertus Van Den Poll Thomsen, Copenhagen (DK)

Correspondence Address: HARNESS, DICKEY & PIERCE, P.L.C., P.O. BOX 8910, RESTON, VA, 20195, US

(21) Appl. No.: 10/844,351

(22) Filed: May 13, 2004

Related U.S. Application Data
(60) Provisional application No. 60/469,831, filed on May 13, 2003.

(51) Int. Cl. G06F 17/60

(52) U.S. Cl. 705/3

(57) ABSTRACT

The invention provides direct and persistent access to digital data, in particular to digital medical data. Based upon the identity of the user 10, a list of relevant medical data is presented to the user 12 by accessing a repository of attributes relating to the digital medical data. In order to generate the list a user profile is consulted 11. The user profile dictates the items within the list on the basis of a rule based comparison between the user profile and the attributes. The user selects from the list the medical data which should be presented, and the requested medical data is subsequently presented to the user 15.

### FIELD OF THE INVENTION

The present invention relates to providing direct and persistent access to digital data. In particular, the invention relates to providing direct and persistent access to digital medical data.

### BACKGROUND OF THE INVENTION

Digital medical images are currently acquired from diverse imaging modalities such as 3D or volume scanners, e.g.: Computed Tomography (CT), Magnetic Resonance Imaging (MRI), Ultrasound (US), Positron Emission Tomography (PET), and Single Photon Emission Computed Tomography (SPECT), as well as 2D-scanners, such as Computed Radiography (CR) and Digital Radiography (DR). These image data as well as patient information and records are currently created and stored on various electronic database systems that are tailored for handling image data, patient demographic information, laboratory requests and results, pharmacy data, and reservations and bookings of healthcare resources (beds, procedures, etc.). A plurality of computer-based systems has emerged to process the diverse patient-related data. These include image management systems under the broad category of Picture Archiving and Communications Systems (PACS systems) which implement the Digital Imaging and Communications in Medicine standard (DICOM standard) and administrative and non-graphical data systems that implement standards such as the Health Level Seven (HL7) standard, the Electronic data interchange for administration, commerce and transport (EDIFACT) standard, and the International Health Exchange (IHE) framework.

PACS systems are often dedicated client-server based systems, which require clinical users to log in to a client station and then execute queries in order to fetch the relevant patient image data for viewing. Such image data may also necessitate user-driven manipulation in order to obtain the exact view or analysis desired. Likewise, non-graphical patient data are often accessed via dedicated applications or workstations, requiring queries and searching in order to locate and view relevant data. In fact, at most full-service healthcare facilities, clinical users must navigate a process involving dozens to hundreds of separate computer user-interface interactions in order to obtain the necessary electronic information for a given patient.

Furthermore, for many existing systems, once a collection of patient-related data has been gathered, there exists no simple way to re-visit this collection electronically at another time or location. It is necessary to re-execute the steps that were originally followed.

A system for distribution of medical images from existing picture storage systems to a plurality of heterogeneous client workstations is disclosed in the U.S. Pat. No. 6,260,021. The system includes one or more interface engines, for providing image objects with a uniform structure regardless of the type of existing system on which they are stored, and image server middleware, for managing the distribution of image objects.

In the U.S. Pat. No. 6,014,638 patent a system for customizing content and presentation of content for computer users is disclosed. The system monitors and records a user's needs and preferences for subsequent computer displays in connection with electronic shopping. Displays are customized in accordance with the user's needs and preferences.

### DESCRIPTION OF THE INVENTION

It is an object of the present invention to provide a method for direct and persistent access to digital medical data.

According to a first aspect, the invention discloses a method for providing medical data relating to individuals, said method comprising the steps of:
accessing a user profile of a requesting user,
accessing a repository of attributes relating to the medical data,
generating a set of data objects based on a rule based comparison between the user profile and the attributes, where each data object represents a data set related to the individual,
generating a list of the data objects which is presented to the user, and
upon a single request action from the user for requesting a data object on the list, displaying the requested medical data for the selected data object.

The medical data may be any type of medical data but is preferably medical image data acquired in connection with a medical scanning of a patient. The preferred medical data comprise both graphical medical data, such as image data and textually based data, e.g. information relating to demographic data, diagnosis, etc.

The medical data are stored on a computer-based system comprising a first and at least a second device. Preferably, the present invention is implemented on a system employing a client-server network system, so that the first device may be a server or it may be a central computer, or a central cluster of computers. The first device may comprise any type of computer, or cluster of computers, with the necessary aggregate storage capacity to store large data sets which, e.g., arise from scanning of a large number of patients on a hospital. The first device should furthermore be equipped with the necessary computing power to be able to handle the demanding tasks of analyzing and manipulating large 3D data sets, such as 3D images of a human head, a chest, etc.

The at least second device may be any type of computer machine equipped with a screen for graphical visualization. The term visualization should be interpreted to include both 2D visualization and 3D visualization. The at least second device may, e.g., be a thin client, a wireless handheld device such as a personal digital assistant (PDA), a personal computer (PC), a laptop computer, a tablet PC or a workstation. The at least second device machine may merely act as a graphical terminal of the first device. The at least second device may be capable of receiving request actions from a user and transferring the requests to the first device, as well as receiving and showing screen images generated by the first device.

The present invention is, however, not limited to implementation on a client-server type system. For example, it may be implemented on any type of system, including a workstation or a PC, or as a program implemented in connection with the Internet.

The user may, e.g., be a clinician, a nurse or the user may be a scientist doing research, such as a researcher in e.g.: medicine, psychology, psychiatry, human biology, biophysics or the like. The user may obtain access to the system via a computer interface in connection with the at least second device, such as a screen, keyboard and pointing device (e.g. a computer mouse). The system may contain delicate information relating to patients, and only authorized personnel may, therefore, be able to obtain access. The user may obtain access to the system in several ways. For example, access may be obtained by inserting an identity card into a card reader, or approaching the card to a card reader which can detect the card identity at a distance. Cards such as cards with an electronic chip incorporated into the card, cards with a magnetic strip, cards with a pattern that may be read optically, or other types of cards may be used. Access may also be obtained by keying in a user name and a password in a similar manner that computer users normally obtain access to a computer or a computer network. In addition the medical data transferred between the first and the at least second device may be encrypted.

Once the user has been identified, the system accesses a user profile, which matches the requesting user. The user profile is preferably stored on the first device. The user profile may be a personal user profile, i.e. a user profile valid only for the requesting user, or it may be a group user profile valid for two or more users. The system then accesses a repository of attributes relating to medical data. In the case that the medical data conforms to the DICOM standard, these attributes are standardized, and may be found as a part of the header for each data object. For example, the data object may be a scanned 3D image of a patient. In this case, the header may contain attributes relating to information concerning the nature of the scanned image, the date and time of the scanning, the number of data points, etc.

After the user profile has been accessed, a set of data objects is generated based on a rule-based comparison between the user profile and the attributes. For example, the user profile may dictate that the list should contain all patients scanned within the last 24 hours, then only patient data scanned for the last 24 hours is contained in the generated data object set. A list where each item represents a data object is generated. The user is after the list has been generated automatically presented with the list. The list may be presented on a computer screen in a graphical or textual manner, e.g. as a list of icons or a text list. The list may contain items representing all data objects where a match is found in the repository of attributes on the basis of the user profile. The list may thus be a listing of data objects, i.e. image objects representing patient data, such as data obtained by medical scanning of a patient. By activating an item on the list by a single request action, e.g. clicking with a computer mouse on the corresponding icon or text element, the medical data for the selected individual is displayed on the screen. A “one-click” access may thereby be obtained to relevant patient data, instead of a long series of user interactions necessary with other methods.

The user profile may contain information concerning user specific preference settings. For example, if the user prefers gray-scale visualization rather than color visualization. Or if, the user prefers to view images from a certain angle, in fact any setting may be contained within the user profile.

The present invention may include a software-implemented application which provide a method for analyzing a profile to determine the preferences of a user, so that the way data is displayed on the screen of the at least second device may be customized in accordance with the user's needs and preferences. The user is thus presented with a system for obtaining direct access to medical data, which is standardized in the overall functionality of the program, but which may be customized to the individual user with respect to which data that may be accessed as well as the presentation of the accessed data.

In connection with the user profile, a user-specific log may be kept. The user-specific log may be used to register all user events while the user is logged onto to the system, as well as the state of the session in relation to all the user events. The user-specific log may be registered by any means possible to register user events. The user-specific log may be registered in a computer cache of a computer connected to the user interface, i.e. a computer that may register all user interactions, the user-specific log may likewise be saved to a disk or any other type of storage medium as a computer file. The user-specific log may be maintained even if the user logs off and stops using the system. If the user at a later time initiates a new session within the system, the user will have the option of starting at the exact stage where the user stopped the last time. Thus, at the beginning of a new session, the user may be presented with the exact same screen image on the screen of the at least second device as in the end of a previous session. The user may in the beginning of a new session be able to choose between continuation of the last session, or starting a new session. In the embodiment where the system is run from a central server via a local client, the state of the session is even not dependent upon the geographical location of the user. Thus the user may initiate a session in one location, e.g. the user's office. Then log off the system. Change location and at another time initiate a new session and continue exactly from where the user left the last time. The actions used in this new session, as well as the actions of a past session are still accessible though an undo function containing either all past user events, or a considerable number of past user events, such as the last 20 user events, the last 50 user events or the last 100 user events. The method thus provides, in addition to direct access to digital medical data, persistent access to digital medical data. Persistent access may be highly relevant for healthcare personnel, as healthcare personnel often do not have fixed working locations, they need to respond to healthcare problems promptly where ever they happen to be, and patients also move both within the same hospital and between different healthcare institutions.

An important feature of the invention is that, in addition to obtaining access to medical data, access may also be obtained to a computer application selected from a pool of computer applications, so that the medical data may be visualized, analyzed and manipulated. The computer application may be a 3D visualization and analysis program enabling the user, e.g., to rotate and zoom a scanned 3D image of the selected patient data, or to view a 2D slice of the patient. The computer applications may be stored on the first device, and may be run from the first device, or it may be stored on and may be run from a device, which is connected to the first device via a computer network connection.

The user profile may also contain information concerning which computer application the selected patient data should be presented in. For example, if the user is a brain surgeon then the user profile may contain information so that the user always may be presented to e.g. an application for MRI scans, whereas an orthopedist may be presented with an application for CT scans. The user-specific log registers the application, which is used, as well as all user events within this application. The system therefore allows for a continuation of working within the exact same state of an application, even if the user does log off the system, change location, and log on again at a later time. The selection of the computer application is normally based upon a type of the medical data, such that if the user is requesting CT data, the data is visualized using a specific application for CT data.

The user profile may additionally contain information relating to the location of the user, as well as the time of the day of a request. The system may on the basis of the user profile, in combination either with the location, the time or both, be able to determine the task at hand for the user. This may be useful if the user needs or wants different data presented according to where the user is situated geographically or the time of the day. The location of the user may be determined from the location of the computer with which the user accesses the server. In the case where the computer is a stationary computer, such as a workstation, a thin client or a PC, the location may be determined upon the known location of the computer. Alternatively, the location of the computer may be determined based upon an access point of the computer network. This is especially relevant if the computer is a mobile machine such as a handheld device, e.g. a PDA or a laptop computer.

The user profile may further comprise information relating to a schedule of the user that is stored in another software application. For example, the user profile may even be correlated with a digital personal organizer, such as Microsoft Outlook™ or a handheld organizer such as a Palm Pilot™ or the like.

The user profile may also comprise information relating to attributes of previously requested graphical medical data. If the user primarily retrieves certain types of images, the user profile may be dynamically updated, so that it is this type of image which is presented in the list from where the user has access using a single request action. Other types of information may also be dynamically updated, such as user preferences. In addition to, or instead of, dynamical update of the user profile, the user profile may also be updated manually. Either by an administrator, such as a super user, or any person or group of persons which may have special authorization to update the user profiles. The user may also update the user profile. For example, by using a special profile administration application put at the disposal of the user.

The data to which access is gained by the present method may be data comprising graphical medical data. For example image data acquired in connection with a medical scanning of a patient. Preferably the image data may conform to the DICOM standard implemented on PACS systems. In particular the graphical medical data may be both 3D graphical medical data such as data from MRI, CT, US, PET, and SPECT, as well as 2D graphical medical data such as data from: CR and DR. The graphical medical data may in addition to being visualized, be manipulated and analyzed in accordance with standard manipulation and analysis routines. The manipulation may be any standard manipulation of the data such as rotation, zooming in and out, cutting an area, or subset of the data, etc. The manipulation may also be less standard manipulation, or it may be unique manipulation specially developed for the present system.

In addition to graphical data, access to textual medical data relating to the selected individual may also be gained. Preferably the textual medical data is based on data which conforms to the HL7 standard or the EDIFACT standard. A feature, such as a button to be pushed, a menu point to be selected, etc., may be available, so that when this feature is activated the textual medical data stored for the patient related to the data object which is visualized is retrieved from the first device. The interchange of graphical and/or medical data may be based on the IHE framework for data interchange.

According to a second aspect of the invention, a computer system for providing medical data relating to individuals is disclosed, the system comprising:
a first device and a at least second device, where the first device and at least second device are connected together in a computer network,
the at least second device comprise inputting means capable of accepting request actions and visualization means,
a user profile of a requesting user, where said user profile is stored on and accessible from the first device, and
a repository of attributes relating to the medical data is stored on and accessible from the first device,
   wherein a set of data objects based on a rule based comparison between the user profile and the attributes is generated, where each data object represents a data set related to the individual, and a list of the data objects is generated and presented to the user, so that upon a single request action from the user for requesting a data object on the list, displays the requested medical data for the selected data object on the visualization means.

### BRIEF DESCRIPTION OF THE DRAWINGS

Preferred embodiments of the invention will now be described in details with reference to the drawings in which:

FIG. 1 shows an overview of a preferred embodiment;

FIG. 2 shows a flowchart of the steps involved in a preferred embodiment of the present invention;

FIG. 3 shows a scheme of the data structure and hierarchy of information that allow direct access to desired patient data;

FIG. 4 illustrates direct access of patient data consisting of CT images;

FIG. 5 shows an example of a user log; and

FIG. 6 illustrates the functionality of the user log.

### DETAILED DESCRIPTION OF THE INVENTION

The present invention provides a method and a system where access can rapidly be obtained to medical data. The invention is in the following described with reference to a preferred embodiment where the invention is implemented as a software program on a client-server network computer system. The server is part of a PACS system and the medical data as well as the applications for visualization and analysis are stored, operated and processed on the server, or on a device which is connected to server via a computer network connection. The software application is run on a central computer server system, but all user interactions with it, is communicated through a client machine connected to the server. The client machine is in the preferred embodiment only able to take request actions from the user, transfer the request to the server and thereafter receive data from the server as a result of the request which is presented on a screen in connection with the client. The disclosed method of obtaining access to medical data is not limited only to work within a single institution, since the client and the server may form a connection, e.g., through the Internet, or through any other type of network connection.

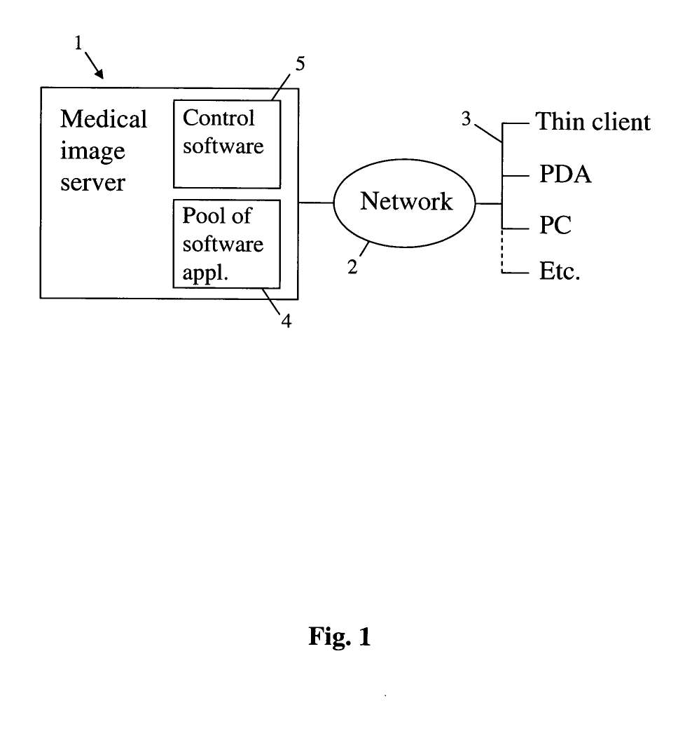

An overview of a preferred embodiment of the system is shown in FIG. 1. Medical image data is acquired e.g. by using a medical scanner, and is afterwards stored on an image server 1 which is part of the PACS system, so that access to the images may be established at any time thereafter. A multitude of clients 3 may be connected to the server through a network connection 2. The network 2 may be any type of network, in the preferred embodiment the network is either an intranet, such as an Ethernet, or the Internet. The client and the server may communicate with each other both through an intranet and through the Internet, as is well known from network systems.

The client 3 can be any type of computer machine equipped with a screen for graphical visualization as well as means for registering request actions, e.g. a keyboard and a computer mouse. The client may be, e.g., a thin client, a wireless handheld device such as a personal digital assistant (PDA), a personal computer (PC), etc.

In addition to the medical data, a pool of applications 4 for data analysis and visualization is stored on the server and may be run therefrom. The pool of applications may also be stored and may be run from a device that is connected to the server via a computer network connection. The server is equipped with the necessary computing power to be able to handle the demanding tasks of analyzing and manipulating large 3D objects, such as a 3D image of a human head, a chest, etc. All data and data applications for visualization and analysis are stored, operated and processed on the server. The handling of a session and all events in connection with this is done by control software 5. The control software receives user requests, retrieves data from the medical server, calls the proper software application from the pool of available applications, handles the user profile, maintains a log of the user events as well as the state of the session, etc.

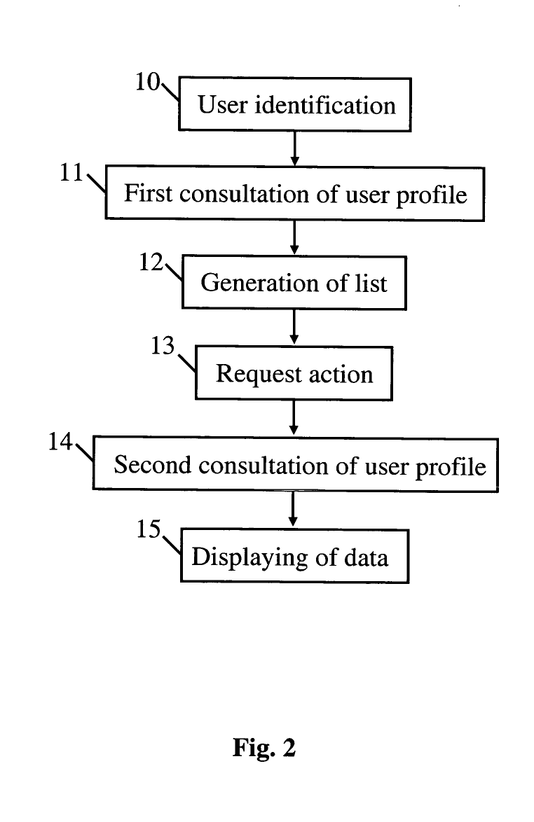

FIG. 2 shows a flowchart of the steps involved in a preferred embodiment of the present invention. FIG. 2 is explained in connection with a preferred embodiment wherein the user is a clinician with a variety of tasks. The clinician is connected to a radiology department and the patients he deal with, are patients who have undergone medical scanning, such as CT scanning. The patients may later undergo surgery on the basis of images acquired in connection with a medical scanning.

As a first task of a given day, the clinician may attend a morning conference together with a team of other clinicians, where the team discusses the patients under treatment at the moment, such conferences are common in hospitals. A typical subject on a morning conference may be the patients which have undergone medical scanning during the last 24 hours. To assist the discussion a thin client equipped with a projector is present in the conference room.

As a first step 10 the user is identified, i.e. the clinician is identified, e.g. by inserting an identity card into a card reader. Having established the user identity, a first consultation 11 of the clinician's user profile is done. The user profile of the clinician contains a rule stating that if the clinician is making a request from the conference room, a list of the patients, who have undergone scanning within the last 24 hours, should be generated. The list is generated 12 and presented on the screen. The clinician now chooses an item on the list. The item represents a data object related to a patient who should be discussed, and by a single request action 13, i.e. a single click on the item, an image of the requested data object related to the chosen patient is displayed 15 on the screen. In order to display the requested data object, a second consultation 14 of the user profile is done. In further detail, the request is sent to the server, which interprets the request and obtains the relevant image data from a storage medium to which it is connected and the image data is displayed on the client machine.

The clinician may use a multitude of 3D graphical routines, such as rotation, zooming, etc. for example to obtain insight into the location of an object to be operated on.

Thus, simply by logging on to the system the user is presented with a list of relevant patients, and subsequently by a single request action retrieves the data of a patient of choice. Such a system saves valuable time for clinicians with a heavy schedule. The data may further be presented in a way dictated by the user profile, which is the reason for the second consultation, so that the clinician need to do no further manipulation of the data before the discussion may begin.

The same clinician may later during the day attend to rounds in a ward, carrying a personal digital assistant (PDA) in order to facilitate a discussion with the patients, or to facilitate patients knowledge of their condition. Before starting the rounds, the clinician logs in and as ward rounds are recurring events, the system will upon log on, on the basis of the time of the day, automatically determine the task of the clinician. The clinician is presented with a list of the relevant patients. The list may even be updated according to the location of the clinician, so that the list only contains patients present at the ward where the clinician is located.

In the afternoon, the clinician may prepare for an operation on a patient that has been discussed at the morning conference. The clinician is in the clinician's office and the user profile contains a rule stating that the clinician should be presented with all patients which the clinician is assigned to, the clinician chooses the patient which was discussed at the mornings conference. After the data has been retrieved, the clinician has a choice of resuming the session from where it was left after the morning session, and the clinician chooses to resume the session of the conference. By doing so, the clinician has access to all the manipulation of the data which were performed during the conference.

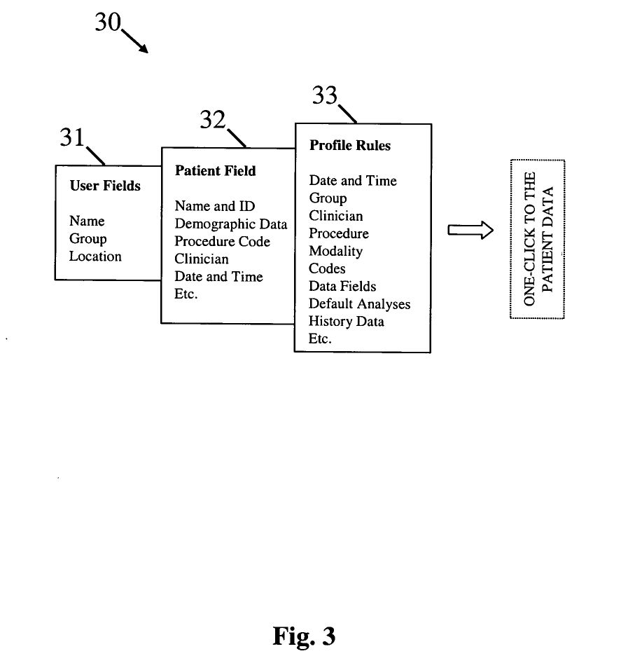

In FIG. 3, a scheme 30 of the data parameters and hierarchy of information that allows direct access to desired patient data is shown. Three levels of information 31, 32 and 33 have to be provided. Most of the information is, however, already available for the system.

The first level 31 contains information concerning the user. This information is provided at log in. The second level 32 contains information concerning the patient. This is selected upon the request action, since all list items represent a data object of a specific patient. The third level 33 contains information concerning the profile rules. These rules are a part of the user profile.

Upon the single request action a data object related to a patient is presented. The application used for presenting the data objects is generally referred to as a clinical application module or CAM. A CAM is a software application that can be started in a specific state with a single start action, such as a single mouse click, or more generally with a single program call. The specific state is specified by data parameters 30. The CAM may be any type of program, e.g. a 3D-visualization program. The exact parameters used for starting the CAM varies with the nature of the CAM, however for each type of CAM exist a well-defined parameter list defining the initial state.

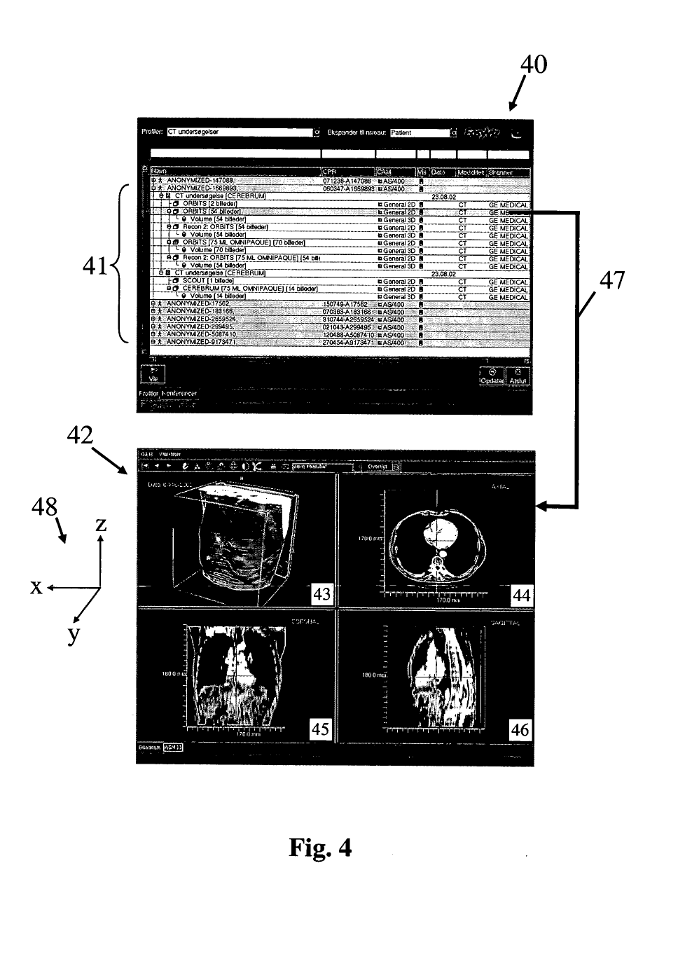

In FIG. 4, two screenshots, obtained in connection with a computer implementation of a preferred embodiment of the invention, are presented. A first screenshot 40 shows the list 41 of data objects, i.e. patient images, which is presented to the user after user identification. The list is generated upon user login, using the user profile. The user can click on a selected data object 47 in order to show the data object. The second screenshot 42 presents an example of a data object that is shown using a CAM for 3D visualizing of CT data. The screenshots show a chest of a patient in the upper left corner 43. A reference 3D coordinate system 48 is also shown. The remaining three quarters of the screenshot show three plane cuts of the chest: an xy-plane 44, an xz-plane 45, and a yz-plane 46.

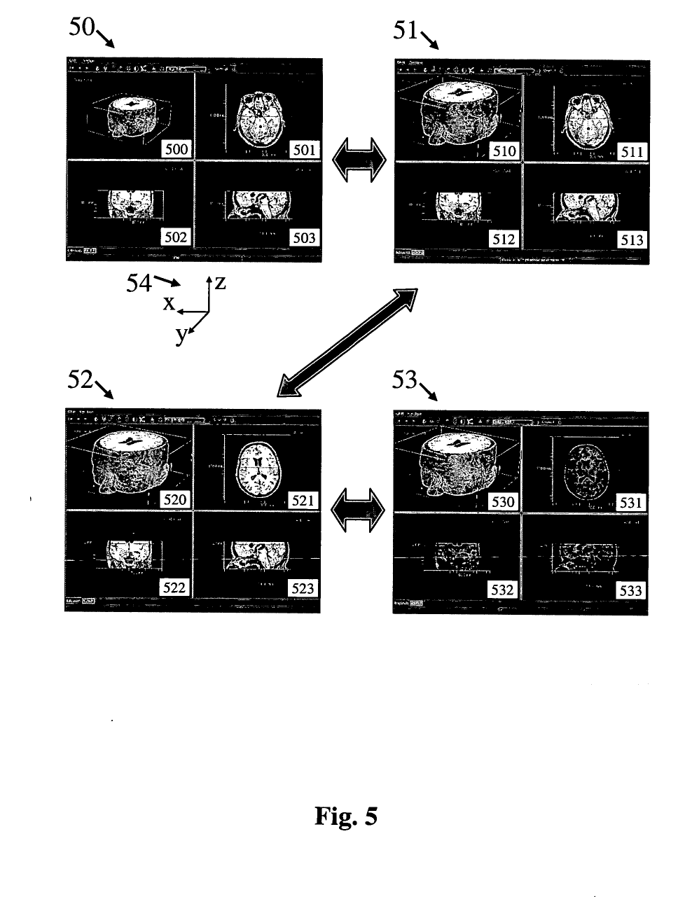

In FIG. 5, an example of the user log and the correspondence to screen images is presented. The user log is illustrated in relation with undo and redo functionality. The image in the upper left corner 50 shows a screenshot of a particular data set. This initial state is registered in the user log. The screenshots are like in FIG. 4 parted in four parts. In the upper left corners 500, 510, 520 and 530 of all screenshots are a 3D view of a CT object shown. In the upper right corners of the screen shots 501, 511, 521 and 531 are a slice obtained along an xy-plane shown, in the lower left corners 502, 512, 522 and 532 are a slice obtained along an xz-plane shown, and in the lower right corners 503, 513, 523 and 533 are a slice obtained along a yz-plane shown.

In the second image 51 is a possible next user step shown: the user has zoomed in on the volume data (510 changed with respect to 500). The resulting state is logged. The user may undo at anytime to obtain the former step 50. After this, the user changes the position of the visualized xy-plane 52 (521 changed with respect to 511). The result is once again registered in the user log. The user may again undo at anytime to obtain the former step 51. Finally, the color settings are changed on all plane views resulting in that the three slices 531, 532 and 533 are darkened. The undo/redo functionality allows the user to step back and forward through all of these states at will.

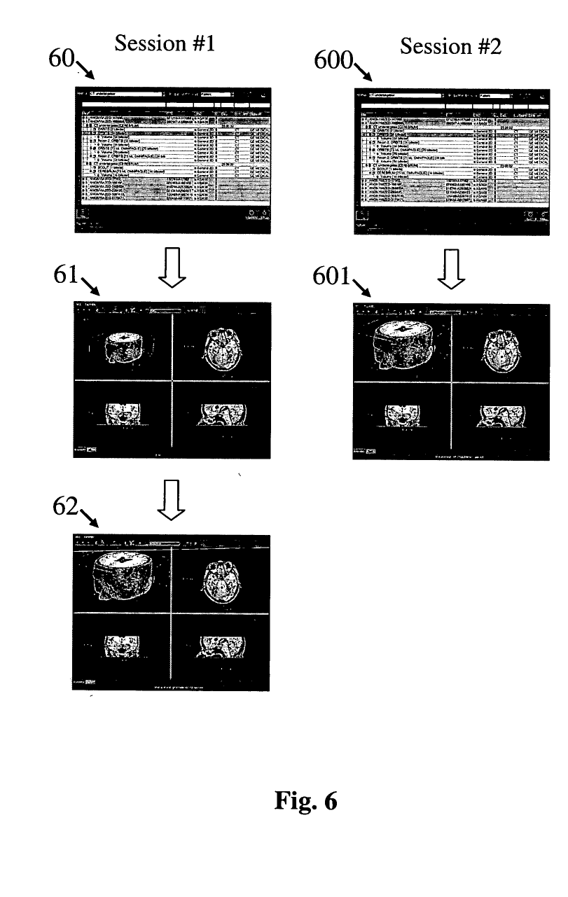

FIG. 6 illustrates the user log and how it is used for saved state functionality. During a first session 60, 61, 62, the clinician logs on 60, finds the correct data set and prepares the view on the data by zooming in 61, 62. The user saves this state and starts a second session later 600, 601, possibly at a different location. The user does not have to go through all steps again—instead the user can simply load the saved state and continue working from the same state the user left after session #1. The state of the session is thus persistent in both time and location. The persistency of the state is here illustrated for a rather simple modification of data. However, in many cases the series of modifications may be quite long and at best tedious or even impossible to recreate without the assistance of the method disclosed herein.

Although the present invention has been described in connection with preferred embodiments, it is not intended to be limited to the specific form set forth herein. Rather, the scope of the present invention is limited only by the accompanying claims.

1. A method for providing medical data relating to individuals, said method comprising the steps of:
accessing a user profile of a requesting user,
accessing a repository of attributes relating to the medical data,
generating a set of data objects based on a rule based comparison between the user profile and the attributes, where each data object represents a data set related to the individual,
generating a list of the data objects which is presented to the user, and
upon a single request action from the user for requesting a data object on the list, displaying the requested medical data for the selected data object.

2. A method according to claim 1, wherein the medical data is graphical medical data.

3. A method according to claim 1, wherein actions of the user as well as a state of the session are registered in a user-specific log.

4. A method according to claim 1, wherein the previous actions of a user, within the same or past sessions, are accessible through an undo function.

5. A method according to claim 1, wherein the medical data is displayed via a computer application selected from a pool of applications.

6. A method according to claim 5, wherein a selection of the computer application is based upon the user-profile.

7. A method according to claim 5, wherein a selection of the computer application is based upon a type of the medical data.

8. A method according to claim 1, wherein the medical data is presented in accordance with user-specific preference settings.

9. A method according to claim 3, wherein the medical data at the beginning of a new session is presented as in the end of a previous session, and where the state of the new session is created on the background of the user-specific log.

10. A method according to claim 1, wherein the user profile comprises information relating to a location of the user.

11. A method according to claim 10, wherein the location of the computer is determined on the basis of an access point of the computer to a computer network.

12. A method according to claim 1, wherein the user profile comprises information relating to a time of the day of the request.

13. A method according to claim 1, wherein the user profile comprises information relating to attributes of previously requested medical data.

14. A method according to claim 1, wherein the user profile comprises information relating to a schedule of the user.

15. A method according to claim 1, wherein the user profile is dynamically updated.

16. A method according to claim 2, wherein the graphical medical data is based on data which conforms to the DICOM standard implemented on PACS systems.

17. A method according to claim 2, wherein the graphical medical data is both 3D graphical medical data such as data from: MRI, CT, US, PET, and SPECT, as well as 2D graphical medical data such as data from: CR and DR.

18. A method according to claim 1, wherein the data comprises textual medical data relating to the selected individual.

19. A method according to claim 18, wherein the textual medical data is based on data which conforms to the HL7 standard.

20. A method according to claim 18, wherein the textual medical data is based on data which conforms to the EDIFACT standard.

21. A method according to claims 16, wherein the interchange of graphical and/or medical data is based on the IHE framework for data interchange.

22. A method according to claim 2, wherein the graphical medical data in addition to being visualized can be manipulated and analyzed in accordance with standard manipulation and analysis routines.

23. A method according to claim 1 wherein the medical data is encrypted.

24. A computer program adapted to perform the method of claim 1, when said program is run on a computer-network system.

25. A computer readable data carrier loaded with a computer program according to claim 24.

26. A computer system for providing medical data relating to individuals, said system comprising:
a first device and a at least second device, where the first device and at least second device are interconnected via a computer network,
the at least second device comprise inputting means capable of accepting request actions and visualization means,
a user profile of a requesting user, where said user profile is stored on and accessible from the first device, and
a repository of attributes relating to the medical data is stored on and accessible from the first device,
wherein a set of data objects based on a rule based comparison between the user profile and the attributes is generated, where each data object represents a data set related to the individual, and a list of the data objects is generated and presented to the user,
so that upon a single request action from the user for requesting a data object on the list, displays the requested medical data for the selected data object on the visualization means.

27. A computer system according to claim 26, wherein said computer system is a client-server system.

28. A computer system according to claim 27, wherein the server in said computer system comprises software adapted to handle graphical data objects and, wherein the client comprises visualization means to visualize graphical data objects.

29. A system according to claim 26, wherein the first device further comprises means for encrypting data to be sent via the computer connection between the first device and the at least second device, and wherein the at least second device comprises means for decrypting the received data.

30. A system according to claim 26, wherein the at least second device and the first device communicate via a common network connection.

31. A system according to claim 26, wherein the first device is a computer server system.

32. A system according to claim 26, wherein the at least second device is a thin client, a work station second device, a PC, a laptop computer or a wireless handheld device.

33. A method according to claim 18, wherein the interchange of graphical and/or medical data is based on the IHE framework for data interchange.
